(19) United States
(12) Patent Application Publication
(10) Pub. No.: US 2022/0004374 A1
(43) Pub. Date: Jan. 6, 2022

(54) PROGRAM UPDATE SYSTEM AND UPDATE PROCESSING PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shogo Kamiguchi, Yokkaichi-shi, Mie (JP)

(21) Appl. No.: 17/291,671

(22) PCT Filed: Oct. 17, 2019
(86) PCT No.: PCT/JP2019/040791

§ 371 Date: May 6, 2021

(30) Foreign Application Priority Data
Nov. 6, 2018 (JP) 2018-209122

(51) Int. Cl. G06F 8/65; B60W 50/00

(52) U.S. Cl. CPC G06F 8/65; B60W 2556/45; B60W 2050/0083; B60W 50/00

(57) ABSTRACT

A program update system includes a plurality of general-purpose ECUs, each capable of executing a plurality of types of programs, and exhibit different functions in accordance with a type of program that is executed. The general-purpose ECUs include an ECU in operation in a state of outputting information for controlling an on-vehicle apparatus mounted in a vehicle and an ECU on standby in a state of not outputting information for controlling the on-vehicle apparatus. When updating a program, the ECU on standby obtains an update program transmitted from an external server, stores the update program in a storage unit thereof, and changes to an ECU in operation that outputs information for controlling the on-vehicle apparatus, while the ECU in operation that is executing a previous-version program corresponding to the update program stops outputting information for controlling the on-vehicle apparatus, and changes to an ECU on standby.

### CROSS-REFERENCE TO RELATED APPLICATIONS

This application is the U.S. national stage of PCT/JP2019/040791 filed on Oct. 17, 2019, which claims priority of Japanese Patent Application No. JP 2018-209122 filed on Nov. 6, 2018, the contents of which are incorporated herein.

### TECHNICAL FIELD

This disclosure relates to a program update system and an update processing program.

### BACKGROUND

On-vehicle ECUs (Electronic Control Units) for controlling on-vehicle apparatuses such as powertrain apparatuses for engine control and the like and body apparatuses for air-conditioner control and the like are mounted in a vehicle. Each of the on-vehicle ECUs includes a computation processing unit such as an MPU, a rewritable non-volatile storage unit such as a RAM, and a communication unit for communicating with another on-vehicle ECU, and controls the on-vehicle apparatus as a result of reading a control program stored in the storage unit and executing the program. Furthermore, a relay apparatus (gateway) that has a wireless communication function is implemented in the vehicle, and it is possible to communicate with a program generation apparatus connected to a network out of the vehicle via the relay apparatus, download (receive) a control program for an on-vehicle ECU from the program generation apparatus, and update the control program of the on-vehicle ECU (for example, see WO2016/121442).

An on-vehicle ECU (on-vehicle control apparatus) of WO2016/121442 obtains differential compression data transmitted from the gateway, executes patching software stored in the storage unit of the on-vehicle ECU using, as input data, the obtained differential compression data and an old program, and obtains a new program.

An on-vehicle ECU (on-vehicle control apparatus) of WO2016/121442 performs processing for obtaining a new program using differential compression data and an old program as input data, and thus there is a problem in that, while such obtaining processing is being performed, a period during which the on-vehicle ECU cannot control an on-vehicle apparatus is long.

The present disclosure aims to provide a program update system and the like that can shorten a period during which an on-vehicle ECU cannot control an on-vehicle apparatus when a program of the on-vehicle ECU is updated.

### SUMMARY

A program update system according to one aspect of the present disclosure performs processing for updating a program of on-vehicle ECUs mounted in a vehicle, and includes a plurality of general-purpose ECUs that are included among the on-vehicle ECUs, are each capable of executing a plurality of types of programs, and exhibit different functions in accordance with a type of program that is executed, wherein the general-purpose ECUs include an ECU in operation that is in a state of outputting information for controlling an on-vehicle apparatus mounted in the vehicle and an ECU on standby that is in a state of not outputting information for controlling the on-vehicle apparatus, and, when updating a program of the general-purpose ECUs, the ECU on standby obtains an update program transmitted from an external server that is outside of the vehicle, stores the update program in a storage unit thereof, and changes to an ECU in operation that outputs information for controlling the on-vehicle apparatus, while the ECU in operation that is executing a previous-version program corresponding to the update program stops outputting information for controlling the on-vehicle apparatus, and changes to an ECU on standby.

### Advantageous Effects of Disclosure

According to one aspect of the present disclosure, it is possible to provide a program update system and the like that can shorten a period during which an on-vehicle ECU cannot control an on-vehicle apparatus when a program of the on-vehicle ECU is updated.

### BRIEF DESCRIPTION OF DRAWINGS

FIG. 1 is a schematic diagram illustrating the configuration of a program update system according to a first embodiment (which includes dedicated ECUs).

FIG. 2 is a block diagram illustrating the configuration of general-purpose ECUs and the like.

FIG. 3 is an explanatory diagram illustrating one aspect of configuration information of general-purpose ECUs.

FIG. 4 is an explanatory diagram illustrating one aspect of update of a program of general-purpose ECUs.

FIG. 5 is a flowchart illustrating processing of a control unit of a general-purpose ECU (ECU on standby).

FIG. 6 is a schematic diagram illustrating the configuration of a program update system according to a second embodiment (which does not include dedicated ECUs).

### DETAILED DESCRIPTION OF PREFERRED EMBODIMENTS

First, embodiments of the present disclosure will be listed and described. At least some of the embodiments to be described below may be suitably combined.

A program update system according to one aspect of the present disclosure performs processing for updating a program of on-vehicle ECUs mounted in a vehicle, and includes a plurality of general-purpose ECUs that are included among the on-vehicle ECUs, are each capable of executing a plurality of types of programs, and exhibit different functions in accordance with the type of program that is executed, wherein the general-purpose ECUs include an ECU in operation that is in a state of outputting information for controlling an on-vehicle apparatus mounted in the vehicle and an ECU on standby that is in a state of not outputting information for controlling the on-vehicle apparatus, and, when updating a program of the general-purpose ECUs, the ECU on standby obtains an update program transmitted from an external server that is outside of the vehicle, stores the update program in a storage unit thereof, and changes to an ECU in operation that outputs information for controlling the on-vehicle apparatus, and the ECU in operation that is executing a previous-version program corresponding to the update program stops outputting information for controlling the on-vehicle apparatus, and changes to an ECU on standby.

In this aspect, when updating a program of general-purpose ECUs included among the on-vehicle ECUs, the ECU on standby obtains an update program transmitted from an external server that is outside of the vehicle, and stores the program in the storage unit thereof. An ECU on standby is not outputting information for controlling the on-vehicle apparatus, and thus, even if processing for storing the update program is performed, the on-vehicle apparatus is not affected. In addition, an ECU in operation outputs information for controlling the on-vehicle apparatus while the ECU on standby is performing processing for storing the update program, and thus there is no period during which the ECU in operation cannot control the on-vehicle apparatus. In addition, in a state change between the ECU in operation and the ECU on standby, processing for obtaining the update program and the like is not performed. Therefore, when updating a program of general-purpose ECUs (on-vehicle ECUs), it is possible to shorten the period during which the on-vehicle ECUs cannot control the on-vehicle apparatus.

In the program update system according to one aspect of the present disclosure, when updating a program of the general-purpose ECUs, after an on-vehicle apparatus corresponding to the update program stops, the ECU on standby changes to an ECU in operation that outputs information for controlling the on-vehicle apparatus, and the ECU in operation that is executing the previous-version program corresponding to the update program stops outputting information for controlling the on-vehicle apparatus, and changes to an ECU on standby.

In this aspect, for example, after the on-vehicle apparatus corresponding to the update program has stopped as a result of an IG (ignition) switch of the vehicle being turned off, the ECU in operation stops outputting information for controlling the on-vehicle apparatus, and changes to an ECU on standby, while the ECU on standby starts outputting information for controlling the on-vehicle apparatus, and changes to an ECU in operation. Therefore, it is possible to reliably update the program of the general-purpose ECUs.

In the program update system according to one aspect of the present disclosure, the ECU on standby has a program stored in the storage unit, the program having been executed when the ECU on standby was the ECU in operation, and, when obtaining the update program transmitted from the external server, the ECU on standby deletes the program that was executed when the ECU on standby was the ECU in operation.

In this aspect, the ECU on standby stores and holds, in the storage unit, an old program executed when the ECU on standby was the ECU in operation, and thus, even if a problem occurs in an update program by any chance, it is possible to perform restoration (rollback) using the old program.

In the program update system according to one aspect of the present disclosure, the on-vehicle ECUs include the general-purpose ECU and a dedicated ECU directly connected the on-vehicle apparatus, the general-purpose ECU is not directly connected to the on-vehicle apparatus, generates information for controlling the on-vehicle apparatus, and transmits the information to the dedicated ECU, and the dedicated ECU receives the information transmitted by the general-purpose ECU, and controls the on-vehicle apparatus directly connected thereto based on the information.

In this aspect, each general-purpose ECU exhibits a plurality of different functions in accordance with the type of a program that is executed. Each of the functions corresponds to an on-vehicle apparatuses that is to be controlled, but an on-vehicle apparatus and an ECU that performs drive control of the on-vehicle apparatus need to be directly connected by a wire harness such as a serial cable, or an internal bus. In contrast, the general-purpose ECU is not directly connected to the on-vehicle apparatus to be driven, and generates and outputs information for controlling the on-vehicle apparatus. The dedicated ECU and the on-vehicle apparatus that is to be driven are directly connected, and the dedicated ECU obtains the information output by the general-purpose ECU, and drives the on-vehicle apparatus directly connected thereto based on the information. Therefore, as a result of respectively connecting general-purpose ECUs and on-vehicle apparatuses using individual wire harnesses, it is possible to make cable routing unnecessary. In most cases, a dedicated ECU directly connected to an on-vehicle apparatus that is to be driven is configured to be integral with the on-vehicle apparatus, and the dependency on the mechanism or structure of the on-vehicle apparatus tends to be high, and thus the frequency at which the program of the dedicated ECU is updated is low. In contrast, a program that is executed by the general-purpose ECU is a program for performing processing for generating information for controlling the on-vehicle apparatus, and, in order to improve the running safety or take security measures, the update frequency is higher than the frequency at which the program of the dedicated ECU is updated. Therefore, as a result of the general-purpose ECU executing a program for which the update frequency is high, and the program update system updating the program of the general-purpose ECU, it is possible to efficiently shorten the period during which the general-purpose ECU cannot control the on-vehicle apparatus.

In the program update system according to one aspect of the present disclosure, the general-purpose ECU and the dedicated ECU are connected via a relay apparatus that integrates a plurality of communication systems, and a communication system to which the general-purpose ECU is connected and a communication system to which the dedicated ECU is connected are different.

In this aspect, as a result of the communication system to which the general-purpose ECU is connected and the communication system to which the dedicated ECU is connected being different communication systems, the influence of traffic that occurs on the communication system to which the general-purpose ECU is connected can be reduced on the communication system to which the dedicated ECU is connected. Therefore, when an update program transmitted from an external server outside of the vehicle is relayed by the relay apparatus and transmitted to the general-purpose ECU, it is possible to suppress an increase in traffic on the communication system to which the dedicated ECU is connected due to the update program being transmitted.

An update processing program according to another aspect of the present disclosure causes a computer to execute processing for changing a plurality of general-purpose ECUs, which are included among on-vehicle ECUs mounted in a vehicle, are each capable of executing a plurality of types of programs, and exhibit different functions in accordance with the type of program that is executed, to an ECU in operation that is in a state of outputting information for controlling an on-vehicle apparatus mounted in the vehicle or an ECU on standby that is in a state of not outputting information for controlling the on-vehicle apparatus, and, when updating a program of the general-purpose ECUs, causing the ECU on standby to obtain an update program transmitted from an external server that is outside the vehicle, and store the update program in a storage unit thereof, and changing the ECU on standby to an ECU in operation that outputs information for controlling the on-vehicle apparatus, and causing the ECU in operation that is executing a previous-version program corresponding to the update program to stop outputting information for controlling the on-vehicle apparatus, and changing the ECU in operation to an ECU on standby.

In this aspect, it is possible to cause a computer to function as the program update system as a result of causing the computer to execute the update processing program. The computer is not limited to a computer incorporated in a general-purpose ECU. The computer may also be a computer incorporated in a reprogramming master that controls transmission of an update program to a general-purpose ECU, such as a relay apparatus (gateway) communicably connected to the general-purpose ECU.

The update processing program according to one aspect of the present disclosure further causes the computer to execute processing for causing the general-purpose ECU to generate information for controlling the on-vehicle apparatus, and to transmit the generated information to a dedicated ECU that is included among the on-vehicle ECUs and is directly connected to the on-vehicle apparatus.

In this aspect, as a result of causing the computer to execute the update processing program, the general-purpose ECU generates information, and transmits the information to the dedicated ECU directly connected to the on-vehicle apparatus. Therefore, it is possible to make it unnecessary to directly connect the general-purpose ECU and the on-vehicle apparatus, and to ensure appropriate in-vehicle cable routing.

In the update processing program according to another aspect of the present disclosure, the general-purpose ECU and the dedicated ECU are connected via a relay apparatus that integrates a plurality of communication systems, and a communication system to which the general-purpose ECU is connected and a communication system to which the dedicated ECU is connected are different.

In this aspect, the communication system to which the general-purpose ECU is connected and the communication system to which the dedicated ECU is connected are different communication systems, and thereby it is possible to keep traffic on the communication system to which the general-purpose ECU is connected from affecting the communication system to which the dedicated ECU is connected, when an update program is transmitted.

The present disclosure will be described in detail with reference to drawings showing embodiments thereof. A program update system S according to an embodiment of the present disclosure will be described below with reference to drawings. Note that the present disclosure is not limited to illustrations of these, but is indicated by the claims, and all changes that come within the meaning and range of equivalency of the claims are intended to be embraced therein.

### First Embodiment

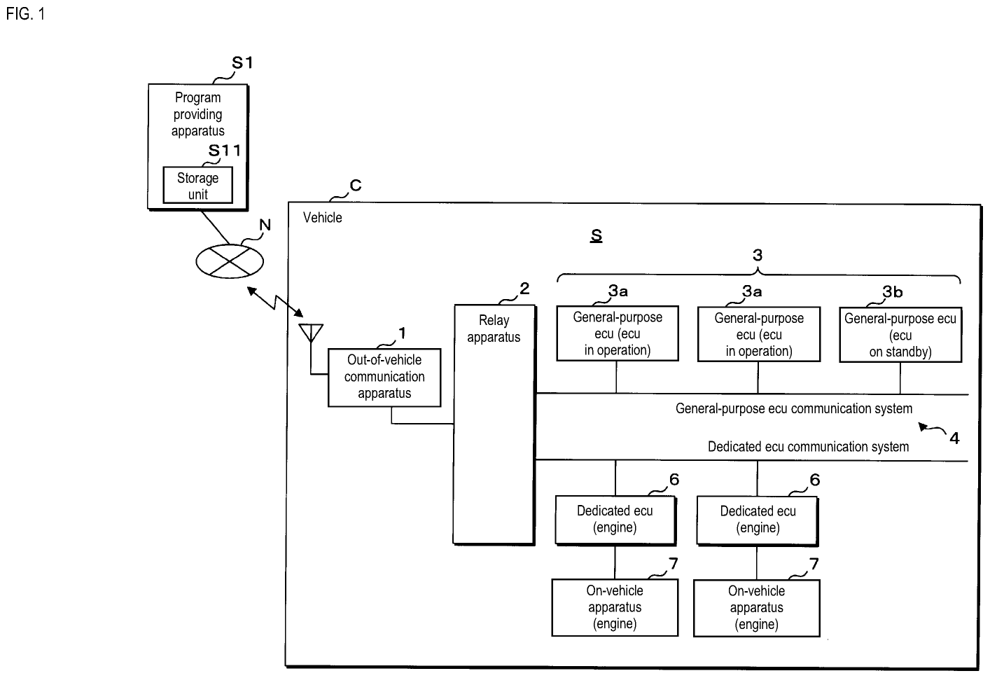

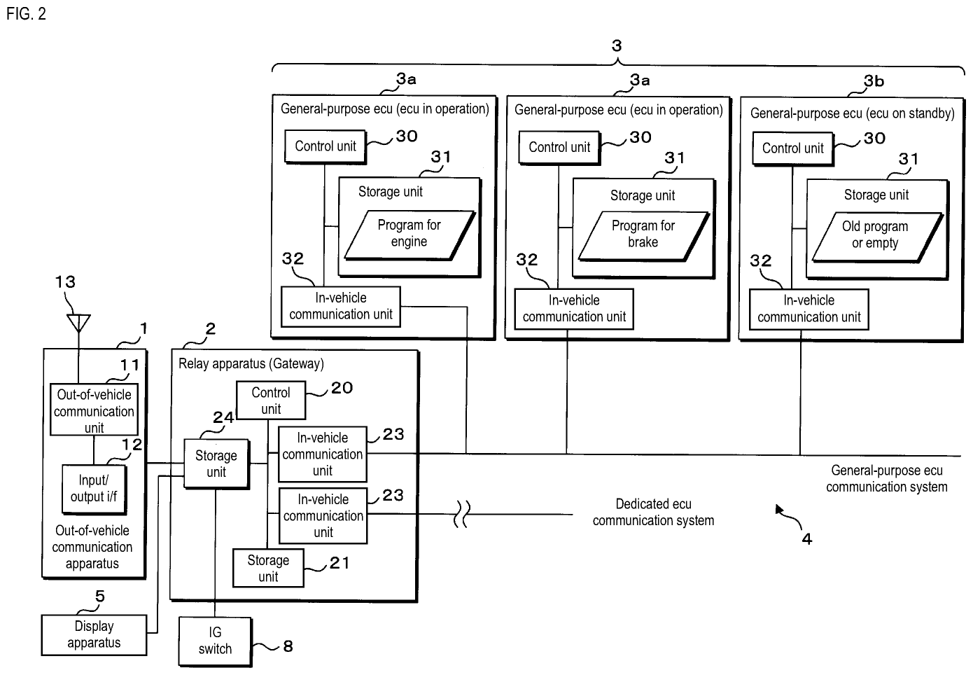

An embodiment will be described below with reference to drawings. FIG. 1 is a schematic diagram illustrating the configuration of a program update system S according to a first embodiment (which includes dedicated ECUs 6). FIG. 2 is a block diagram illustrating the configuration of general-purpose ECUs 3 and the like. The program update system S, which includes an out-of-vehicle communication apparatus 1, a relay apparatus 2, and a plurality of general-purpose ECUs 3, is mounted in a vehicle C.

Connection to an out-of-vehicle network N is made using the out-of-vehicle communication apparatus 1, and the general-purpose ECUs 3 obtain a program or data from a program providing apparatus S1 connected to the out-of-vehicle network N, via the out-of-vehicle communication apparatus 1 and the relay apparatus 2. The relay apparatus 2 may function as a program update apparatus (reprogramming master) that transmits, to the general-purpose ECUs 3, the program or data obtained from the program providing apparatus S1.

The program providing apparatus S1 is a computer such as a server connected to the out-of-vehicle network N such as the Internet or a public network, and is equivalent to an external server that is outside of the vehicle. A program or data for controlling on-vehicle ECUs (the general-purpose ECUs 3 and the dedicated ECUs 6) created by the manufacturer of the on-vehicle ECUs or the like is stored (saved) in a storage unit S11 of the program providing apparatus S1. The program or data is transmitted as an update program to the vehicle C, and is used for updating the program or data of the on-vehicle ECUs mounted in the vehicle C. The program providing apparatus S1 (external server) configured as described above is also referred to as an “OTA (Over The Air) server”. The on-vehicle ECUs mounted in the vehicle obtain the update program transmitted from the program providing apparatus S1 through wireless communication and apply the program as a program to be executed, and can thereby update (reprogram) the program that they execute.

A description will be given later assuming that a program includes program code including a control syntax and the like for an on-vehicle ECU to perform processing, and an external file in which data that is referenced when the program code is executed is written. When the update program is transmitted, the program code and the external file in which the data is written are transmitted from the program providing apparatus S1, for example, as an encrypted archive file.

The plurality of dedicated ECUs 6 and on-vehicle apparatuses 7 directly connected to the plurality of dedicated ECUs 6 using wire harnesses such as serial cables are provided in the vehicle C. Accordingly, in the vehicle C, the general-purpose ECUs 3 and the dedicated ECUs 6 are provided as on-vehicle ECUs. The relay apparatus 2 is a gateway that includes a plurality of segments such as a general-purpose ECU communication system to which the plurality of general-purpose ECUs 3 are connected and a dedicated ECU communication system to which the plurality of dedicated ECUs 6 are connected. The general-purpose ECUs 3 are communicably connected to each other via the general-purpose ECU communication system. The dedicated ECUs 6 are communicably connected to each other via the dedicated ECU communication system. The general-purpose ECUs 3 and the dedicated ECUs 6 are communicably connected to each other via the relay apparatus 2. An in-vehicle LAN 4 is constituted by the general-purpose ECU communication system and the dedicated ECU communication system of the relay apparatus 2.

Although a detailed description will be given later, each of the general-purpose ECUs 3 can execute a plurality of different types of programs, and exhibits different functions in accordance with the type of program that is executed. Specifically, the hardware specifications of the general-purpose ECUs 3 are configured to be the same, for example, and information (data) for controlling the engine is output by applying a program for the engine to one general-purpose ECU 3, and data for controlling the brake is output by applying a program for the brake to another general-purpose ECU 3. Output data is received by a dedicated ECU 6 for the engine or a dedicated ECU 6 for the brake corresponding to the output data, via the relay apparatus 2.

Each of these dedicated ECUs 6 performs drive control of the on-vehicle apparatus 7 directly connected thereto, based on data received from the corresponding general-purpose ECU 3. For example, the dedicated ECU 6 for the engine connected to the on-vehicle apparatus 7 for the engine receives data output from the general-purpose ECU 3 to which the program for the engine is applied, and performs drive control such as drive, start or stop of the on-vehicle apparatus 7 for the engine that is an actuator.

The general-purpose ECUs 3 include an ECU 3a in operation and an ECU 3b on standby. The ECU 3a in operation is a general-purpose ECU 3 that generates and outputs data to be transmitted to a dedicated ECU 6 as described above. The ECU 3b on standby is a general-purpose ECU 3 that is not outputting data, and is on standby. Accordingly, whether a general-purpose ECU 3 is the ECU 3a in operation or the ECU 3b on standby is determined based on the state of the general-purpose ECU 3. A detailed description thereof will be given later in detail with reference to a flowchart and the like.

The out-of-vehicle communication apparatus 1 and the relay apparatus 2 are communicably connected by a wire harness such as a serial cable, for example. The relay apparatus 2 and the on-vehicle ECUs (the general-purpose ECUs 3 and the dedicated ECUs 6) are communicably connected by the in-vehicle LAN 4 that complies with the communication protocol of CAN (Control Area Network/registered trademark), Ethernet (registered trademark), or the like.

The out-of-vehicle communication apparatus 1 includes an out-of-vehicle communication unit 11 and an input/output I/F (interface) 12 for communicating with the relay apparatus 2. The out-of-vehicle communication unit 11 is a communication apparatus for performing wireless communication using the protocol of mobile communication of 3G, LTE, 4G, WiFi, or the like, and transmits/receives data to/from the program providing apparatus S1 via an antenna 13 connected to the out-of-vehicle communication unit 11. Communication between the out-of-vehicle communication apparatus 1 and the program providing apparatus S1 is performed via an external network N such as a public network or the Internet.

The input/output I/F 12 is a communication interface for performing serial communication with the relay apparatus 2, for example. The out-of-vehicle communication apparatus 1 and the relay apparatus 2 communicate with each other via the input/output I/F 12 and a wire harness such as a serial cable connected to the input/output I/F 12. According to this embodiment, the out-of-vehicle communication apparatus 1 and the relay apparatus 2 are different apparatuses, and these apparatuses are communicably connected by the input/output I/F 12 and the like, but there is no limitation thereto. The out-of-vehicle communication apparatus 1 may be included in the relay apparatus 2 as one constituent element of the relay apparatus 2.

The relay apparatus 2 includes a control unit 20, a storage unit 21, and an in-vehicle communication unit 23. The relay apparatus 2 is a gateway configured to obtain, from the out-of-vehicle communication apparatus 1, an update program received from the program providing apparatus S1 by the out-of-vehicle communication apparatus 1 through wireless communication, and transmit (relay) the update program to a general-purpose ECU 3 via the in-vehicle LAN 4. The relay apparatus 2 may be configured as one function unit of a body ECU that controls the entire vehicle C.

The control unit 20 is constituted by a CPU (Central Processing Unit), an MPU (Micro Processing Unit), and the like, and, as a result of reading out and executing a control program and data stored in the storage unit 21 in advance, performs various types of control processing, computation processing, and the like. The control unit 20 is equivalent to an obtaining unit that obtains an update program transmitted from the program providing apparatus S1 via the out-of-vehicle communication apparatus 1.

The storage unit 21 is constituted by a volatile memory element such as a

RAM (Random Access Memory) or a non-volatile memory element such as a ROM (Read Only Memory), an EEPROM (Electrically Erasable Programmable ROM), or a flash memory, and stores, in advance, a control program and data that is referenced at the time of processing. In addition, a control program may be downloaded from an external computer (not illustrated) connected to a communication network (not illustrated), and be stored in the storage unit 21. Furthermore, the storage unit 21 stores configuration information of all of the on-vehicle ECUs (the general-purpose ECUs 3 and the dedicated ECUs 6) that are mounted in the vehicle C, an update program obtained from the program providing apparatus S1, and information regarding the progress when an update program is transmitted to an on-vehicle ECU.

The in-vehicle communication unit 23 is an input/output interface that uses the communication protocol of CAN (Control Area Network), Ethernet (registered trademark), or the like, and the control unit 20 communicates with the on-vehicle ECUs (the general-purpose ECUs 3 and the dedicated ECUs 6) connected to the in-vehicle LAN 4, via the in-vehicle communication unit 23 or another on-vehicle device such as the relay apparatus 2. A plurality of (in the figure, two) in-vehicle communication units 23 are provided, and the communication systems that constitute the in-vehicle LAN 4 are connected to the respective in-vehicle communication units 23. As a result of providing a plurality of in-vehicle communication units 23 in this manner, the in-vehicle LAN 4 is divided into a plurality of segments. As shown in FIG. 1, as a result of connecting the plurality of general-purpose ECUs 3 to one segment, the one segment functions as the general-purpose ECU communication system. As a result of connecting the plurality of dedicated ECUs 6 to the other segment, the segment functions as the dedicated ECU communication system.

The general-purpose ECUs 3 each include a control unit 30, a storage unit 31, and an in-vehicle communication unit 32. The control unit 30 is constituted by a CPU or an MPU. The in-vehicle communication unit 32 is an input/output interface that uses a communication protocol that is similar to that of the in-vehicle communication unit 23 of the relay apparatus 2. The control unit 30 receives, via the in-vehicle communication unit 32, an update program transmitted (relayed) from the relay apparatus 2, and obtains the update program.

The storage unit 31 is constituted by a volatile memory element such as a RAM (Random Access Memory), or a non-volatile memory element such as a ROM (Read Only Memory), an EEPROM (Electrically Erasable Programmable ROM), or a flash memory, and stores a program or data of the general-purpose ECU 3. This program or data is to be updated using an update program that is transmitted from the relay apparatus 2.

The general-purpose ECUs 3 are each configured to be able to execute a plurality of different types of programs. For example, the storage unit 31 of a general-purpose ECU 3 stores a program for the engine, and as a result of the control unit 30 of the general-purpose ECU 3 reading out and executing the program for the engine, the general-purpose ECU 3 generates information for controlling the engine (the on-vehicle apparatus 7 for the engine), and transmits (outputs) the information. In addition, if the storage unit 31 of a general-purpose ECU 3 stores a program for the brake, as a result of the control unit 30 of the general-purpose ECU 3 reading out and executing the program for the brake, the general-purpose ECU 3 generates information for controlling the brake (the on-vehicle apparatus 7 for the brake), and transmits (outputs) the information. In this manner, the general-purpose ECUs 3 are each configured to exhibit different functions in accordance with the type of program stored in the storage unit 31.

As described above, the general-purpose ECUs 3 include the ECU 3a in operation and the ECU 3b on standby. The storage unit 31 of the ECU 3a in operation stores a program that is currently executed. The storage unit 31 of the ECU 3b on standby stores a previous-version program that has been executed before (old program). Note that, if the program of the general-purpose ECUs 3 has never been updated using an update program, the storage unit 31 of the ECU 3b on standby is empty without any program stored therein. The storage unit 31 of each of the general-purpose ECUs 3 stores information regarding the operation state thereof. The information regarding the operation state is, for example, flag data indicating “in operation” or “on standby”. Although a detailed description will be given later, the storage unit 31 of each of the general-purpose ECUs 3 stores the configuration information of all of the general-purpose ECUs 3, in other words the configuration information of all of the general-purpose ECUs 3 is shared among the general-purpose ECUs 3.

The configuration information includes information regarding the operation state, and thus each of the general-purpose ECUs 3 can recognize not only the operation state thereof but also the operation states of all of the general-purpose ECUs 3, and can recognize which general-purpose ECU 3 is in operation (the ECU 3a in operation) and which general-purpose ECU 3 is on standby (the ECU 3b on standby).

Similarly to the general-purpose ECUs 3, each of the dedicated ECUs 6 includes a control unit, a storage unit, and an in-vehicle communication unit (not illustrated). In addition, the dedicated ECU 6 includes an input/output I/F (not illustrated) similar to the relay apparatus 2, and is directly connected to the on-vehicle apparatus 7 in a communicable manner using a wire harness such as a serial cable connected to the input/output I/F. As described above, a dedicated ECU 6 receives data (information for controlling the on-vehicle apparatus 7) output from the general-purpose ECU 3 to which a program (program for the engine) corresponding to the on-vehicle apparatus 7 (for example, the on-vehicle apparatus 7 for the engine) directly connected to the dedicated ECU 6 is applied, and performs drive control such as drive, start or stop of the on-vehicle apparatus 7 directly connected to the dedicated ECU 6, based on the received data.

A display apparatus 5 is communicably connected to an input/output I/F 24 of the relay apparatus 2 by a wire harness such as a serial cable. The display apparatus 5 is an HMI (Human Machine Interface) apparatus such as a display of a car navigation. Data or information output from the control unit 20 of the relay apparatus 2 via the input/output I/F 24 is displayed on the display apparatus 5, for example. A configuration may be adopted in which the relay apparatus 2 transmits, to the display apparatus 5, information regarding the states of the general-purpose ECUs 3 (whether or not each of the general-purpose ECUs 3 is the ECU 3a in operation or the ECU 3b on standby), and displays the states on the display apparatus 5. The mode of connection between the display apparatus 5 and the relay apparatus 2 is not limited to the mode of connection that uses the input/output I/F 24, and the mode of connection between the display apparatus 5 and the relay apparatus 2 may be a mode of connection that uses the in-vehicle LAN 4.

An IG switch 8 (ignition switch) for starting or stopping the vehicle is communicably connected to the input/output I/F 24 of the relay apparatus 2 by a wire harness such as a serial cable. When the IG switch 8 is turned on or off, the control unit 20 of the relay apparatus 2 obtains (receives) a signal output (transmitted) from the IG switch 8 via the input/output I/F 24. The control unit 20 of the relay apparatus 2 transmits information regarding the IG switch 8 being turned on or off, to the general-purpose ECUs 3 and the dedicated ECUs 6 that are on-vehicle ECUs, via the in-vehicle communication unit 23, based on the obtained signal. Therefore, the general-purpose ECUs 3 can obtain the information regarding the IG switch 8 being turned on or off, based on information transmitted from the relay apparatus 2.

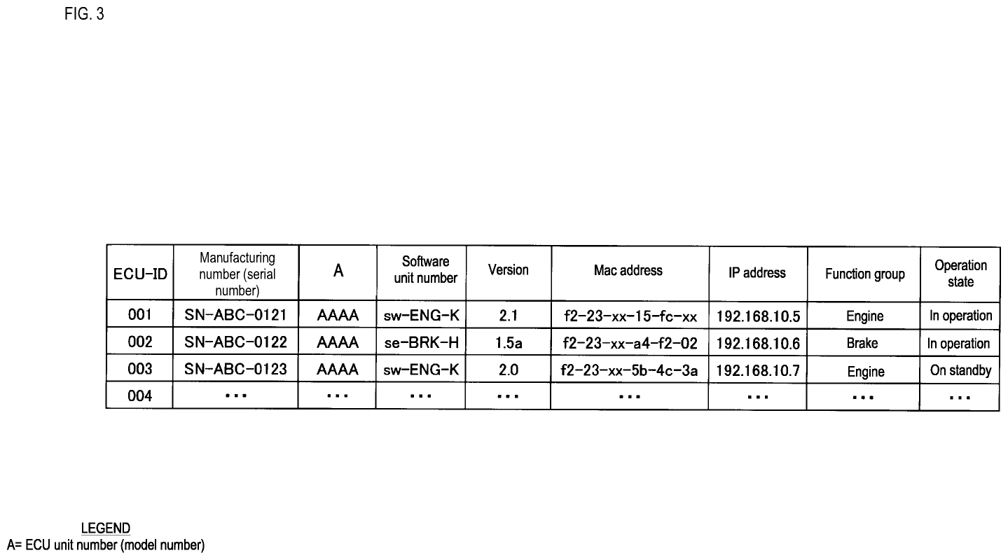

FIG. 3 is an explanatory diagram illustrating one aspect of the configuration information of the general-purpose ECUs 3. The storage unit of each general-purpose ECU 3 stores configuration information of all of the general-purpose ECUs 3. The configuration information is represented as, for example, a group of pieces of information indicated by items in a table shown in FIG. 3 (vehicle configuration information master table). The configuration information includes, for example, manufacturing numbers (serial numbers), ECU unit numbers (unit numbers, model numbers), software unit numbers, versions of programs, MAC (Media Access Control) addresses, IP addresses, function groups, and operation states of the general-purpose ECUs 3, and is managed in association with ECU-IDs represented as sequential numbers that are set so as to not overlap, for the individual general-purpose ECUs 3.

A manufacturing number (serial number) is a number that is provided at the time of manufacturing the general-purpose ECU 3, and is a unique number that is made up of a lot number indicating the manufacturing site and the like and a sequential number at the time of manufacturing and the like, and that enables the ECU to be uniquely specified. An ECU unit number (unit number, model number) is a number for specifying the type of the on-vehicle ECU, and is a component number, for example. A software unit number is a number for specifying the type of software of the program. A version is the version of the program stored in the storage unit.

A MAC address is an address corresponding to a data link layer if the in-vehicle communication unit 32 of the general-purpose ECU 3 is a communication port that complies with the Ethernet standard. The MAC address is a number that is provided at the time of manufacturing the in-vehicle communication unit 32, and is a unique number that is made up of a vendor code indicating the manufacturer, a sequential number at the time of manufacturing, and the like, and that enables the ECU to be uniquely specified. An IP address is an address corresponding to a network layer when performing communication that uses TCP/IP if the in-vehicle communication unit 32 is a communication port that complies with the Ethernet standard.

A function group is a category of the function of the program specified using the software unit number, and indicates the function classification or type of the on-vehicle apparatus 7 to be controlled, for example. An operation state is information indicating “in operation” or “on standby”, as information regarding the state of the general-purpose ECU 3. A general-purpose ECU 3 whose operation state is “in operation” functions as the ECU 3a in operation, and a general-purpose ECU 3 whose operation state is “on standby” functions as the ECU 3b on standby.

The configuration information of a general-purpose ECU 3 includes identification information for identifying the general-purpose ECU 3. An IP address is an address that can be suitably determined in accordance with the settings of the in-vehicle communication unit 32, and thus a serial number or a MAC address is desirably used as identification information for identifying a general-purpose ECU 3.

Assume that, as shown in FIG. 3, there are two general-purpose ECUs 3 (ECU-IDs: 001 and 003) whose function group is the engine. Out of these two, the general-purpose ECU 3 whose ECU-ID is 001 is in operation, functions as the ECU 3a in operation, and is executing a program for the engine. The general-purpose ECU 3 whose ECU-ID is 003 is on standby, functions as the ECU 3b on standby, and stores, in the storage unit thereof, an old program for the engine that was executed in the past (previous-version program). In this manner, the old program is stored in the storage unit of the ECU 3b on standby, and thus, even if a problem occurs in a program that is actually executed, it is possible to continue controlling the on-vehicle apparatus 7 corresponding to the program by performing rollback using the old program.

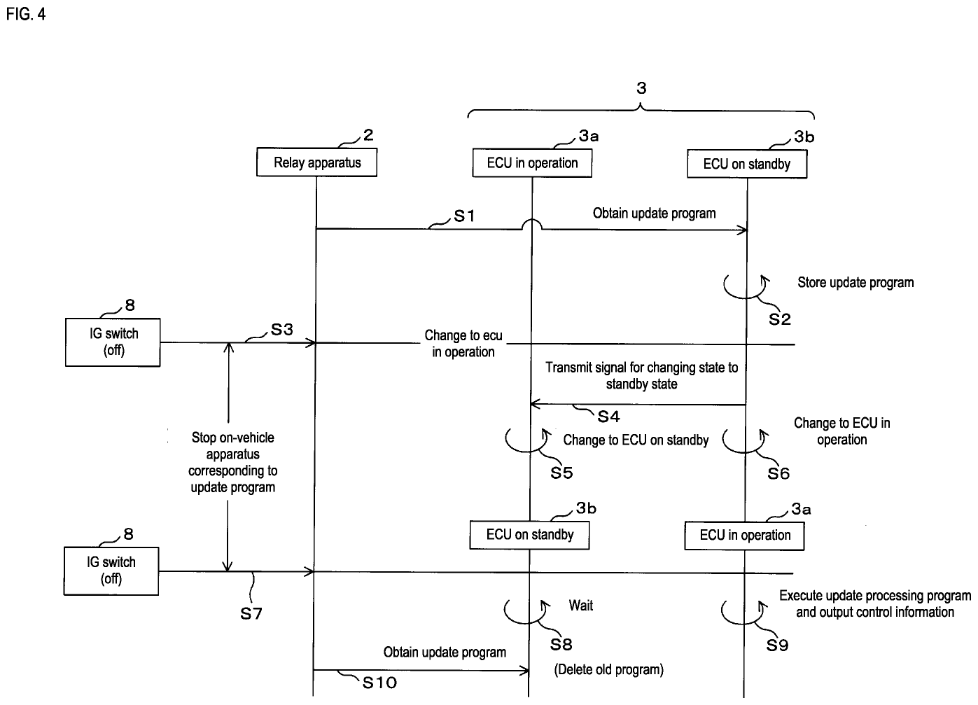

FIG. 4 is an explanatory diagram illustrating one aspect of update of a program of general-purpose ECUs 3. Update of a program that is performed by the program update system S that includes the plurality of general-purpose ECUs 3 (the ECU 3a in operation and the ECU 3b on standby) will be described with reference to a sequence diagram in FIG. 4 that includes processing of the relay apparatus 2, the ECU 3a in operation, and the ECU 3b on standby.

The relay apparatus 2 transmits an update program obtained from the program providing apparatus S1, to the ECU 3b on standby (step Si). The relay apparatus 2 transmits the update program to all of the general-purpose ECUs 3 in a multicast manner, for example. Each of the general-purpose ECUs 3 stores, in the storage unit 31 thereof, information regarding whether the operation state of the ECU 3 is in operation (the ECU 3a in operation) or on standby (the ECU 3b on standby). Accordingly, the ECU 3b on standby obtains (receives) the update program transmitted from the relay apparatus 2. Alternatively, a configuration may be adopted in which the relay apparatus 2 stores, in the storage unit 21, configuration information of all of the general-purpose ECUs 3, specifies a general-purpose ECU 3 that is on standby, in other words, the ECU 3b on standby, and transmits the update program to the ECU 3b on standby in a unicast manner. If the update program is obtained (received) normally, the ECU 3b on standby may transmit (return), to the relay apparatus 2, a message that the update program was successfully received.

The ECU 3b on standby stores, in the storage unit 31 thereof, the obtained (received) update program (step S2). If an old program executed in the past is stored in the storage unit 31 of the ECU 3b on standby, in other words if an old program remains in the storage unit 31, the ECU 3b on standby deletes the old program as preparation processing for obtaining or storing the update program.

The IG switch 8 is turned off (step S3). As a result of the IG switch 8 being turned off, the vehicle C stops. As a result of the vehicle C stopping, the on-vehicle apparatuses 7 connected to the dedicated ECUs 6 also stop. In addition, as a result of the IG switch 8 being turned off, the relay apparatus 2 transmits information regarding the IG switch 8 being turned off, to all of the general-purpose ECUs 3 (the ECU 3a in operation, the ECU 3b on standby). The ECU 3a in operation that has received the information stops generating and transmitting information for controlling the on-vehicle apparatus 7.

The ECU 3b on standby transmits, to the ECU 3a in operation, a signal for changing the state to a standby state (step S4). The ECU 3b on standby references the header information of the update program stored during the processing in step S2, and the like, and specifies the software unit number, version, and function group of the update program. The general-purpose ECUs 3 specify, for example, the ECU 3a in operation (the general-purpose ECU 3 that is in operation) that has the same function group or software unit number as the specified function group or software unit number. For example, if the function group of the update program is the engine, the ECU 3a in operation whose function group is the engine is specified. The ECU 3a in operation is specified, for example, based on a manufacturing number or MAC address. The ECU 3b on standby transmit, to the specified ECU 3a in operation, the signal for changing the state to a standby state.

The ECU 3a in operation that has received the signal for changing the state to a standby state changes to an ECU 3b on standby (step S5). The ECU 3a in operation that has received the signal for changing the state to a standby state changes, in the configuration information stored in the storage unit 31 thereof, the operation state thereof from “in operation” to “on standby”. As a result of changing the operation state from “in operation” to “on standby”, the general-purpose ECU 3, which has been the ECU 3a in operation, changes to an ECU 3b on standby. After changing the configuration information stored in the storage unit 31 thereof and changing to the ECU 3b on standby, the ECU 3b on standby may transmit the changed configuration information to all of the general-purpose ECUs 3 and the relay apparatus 2, for example, in a multicast manner.

The ECU 3b on standby that has transmitted the signal for changing the state to a standby state changes to an ECU 3a in operation (step S6). The ECU 3b on standby that has transmitted the signal for changing the state to the standby state changes, in the configuration information stored in the storage unit 31 thereof, the operation state thereof from “on standby” to “in operation”. As a result of changing the operation state from “on standby” to “in operation”, the general-purpose ECU 3, which has been the ECU 3b on standby, changes to an ECU 3a in operation. After changing the configuration information stored in the storage unit 31 thereof and changing to the ECU 3a in operation, that ECU 3a in operation may transmit the changed configuration information to all of the general-purpose ECUs 3 and the relay apparatus 2 in a multicast manner, for example. Note that, in the configuration information that is transmitted, the software unit number, version, and function group are changed based on the obtained update program, in addition to information regarding the operation state of the ECU.

In this manner, every time the program is updated, the general-purpose ECU 3 that changed its operation state transmits configuration information that includes the operation state thereof and the software unit number, version, and function group corrected based on the obtained update program, to all of the general-purpose ECUs 3 and the relay apparatus 2. Therefore, the general-purpose ECUs 3 and the relay apparatus 2 can always share the most recent configuration information of the general-purpose ECUs 3.

The IG switch 8 is turned on (step S7). As a result of the IG switch 8 being turned on, the vehicle C starts. Information regarding the IG switch 8 being turned on is transmitted from the relay apparatus 2 to all of the general-purpose ECUs 3.

The ECU 3b on standby performs standby processing for waiting for an update program to be transmitted from the relay apparatus 2 (step S8). The same type of program as the update program that was transmitted previously from the relay apparatus 2, in other words an old program that is a previous version of the update program is stored (saved) in the storage unit 31 of the ECU 3b on standby. The ECU 3b on standby does not execute the old program, and performs standby processing. Therefore, the ECU 3b on standby has virtually stopped outputting information for controlling the on-vehicle apparatus 7. “Virtually stopping outputting information for controlling the on-vehicle apparatus 7” is not limited to a case where the ECU 3b on standby has stopped outputting all information. Specifically, the ECU 3b on standby may output information (signal) regarding polling for confirming the state of the dedicated ECU 6 or the on-vehicle apparatus 7, information (signal) to be transmitted to the dedicated ECU 6 or the on-vehicle apparatus 7, or information (signal) to be ignored or discarded by the dedicated ECU 6 or the on-vehicle apparatus 7 for example. “Virtually stopping outputting information for controlling the on-vehicle apparatus 7” means to stop outputting (transmitting) information that affects control of the on-vehicle apparatus 7. Therefore, the ECU 3b on standby may output (transmit) information (signal) that does not affect control of the on-vehicle apparatus 7.

The ECU 3a in operation executes the update program stored in the storage unit 31, and outputs information for controlling the on-vehicle apparatus 7 (step S9). The ECU 3a in operation executes the update program stored during the processing in step S2, generates information for controlling the on-vehicle apparatus 7 corresponding to the update program, and outputs (transmits) the information to the dedicated ECU 6 directly connected the on-vehicle apparatus 7.

The ECU 3b on standby obtains the next update program, similarly to the processing in step S1 (step S10). For example, if information regarding the presence of a new update program is transmitted from the program providing apparatus S1 via the relay apparatus 2, the ECU 3b on standby deletes the old program stored in the storage unit 31 thereof, as preparation processing for obtaining the next update program from the relay apparatus 2 and storing the update program.

An update program is obtained and stored by the ECU 3b on standby while the vehicle C is running, and thus this processing is performed without taking consideration of the remaining capacity of the electric storage apparatus of the vehicle C. The ECU 3b on standby does not generate or output information for controlling the on-vehicle apparatus 7, and thus it is possible to obtain the update program without affecting control of the on-vehicle apparatus 7.

The update program obtained by the ECU 3b on standby can be applied as a result of performing processing for changing the ECU 3b on standby to an ECU 3a in operation while the on-vehicle apparatus corresponding to the update program is stopped, for example, during a period from when the IG switch 8 is turned on until it is turned off. A change from the ECU 3b on standby to the ECU 3a in operation can be made, for example, through processing for changing information indicating the operation state of the ECU from “on standby” to “in operation”, in the configuration information stored in the storage unit 31 of that ECU, and thus the change can be made in a short time. Therefore, it is possible to complete application of an update program, in other words update processing (reprograming processing) of a program in a short time, and shorten the time during which the general-purpose ECUs 3 cannot control the on-vehicle apparatuses 7.

The ECU 3a in operation that has received the signal for changing the state to the standby state changes to an ECU 3b on standby while the on-vehicle apparatus corresponding to the update program is stopped, for example, during a period from when the IG switch 8 is turned off until when it is turned on. After the IG switch 8 is turned on, the ECU 3b on standby that has started does not generate or output information for controlling the on-vehicle apparatus 7. Therefore, it is possible to prevent the old program stored (saved) in the storage unit 31 of the ECU 3b on standby from being executed.

A configuration may be adopted in which, when a problem occurs in the applied update program, the ECU 3a in operation that is executing the update program changes to an ECU 3b on standby, stops execution of the update program, and the ECU 3b on standby changes to an ECU 3a in operation and performs rollback processing for executing the old program thereof. As a result of performing the rollback processing, it is possible to continue controlling the on-vehicle apparatus 7 corresponding to the update program.

The configuration information of all of the general-purpose ECUs 3 is stored in the storage unit 31 of each of the general-purpose ECUs 3, but there is no limitation thereto. A configuration may also be adopted in which the storage unit 31 of each general-purpose ECU 3 stores only the configuration information thereof, and the relay apparatus 2 communicates with the general-purpose ECUs 3, obtains (receives) configuration information of the general-purpose ECUs 3 transmitted from the general-purpose ECUs 3, and integrates the configuration information. Accordingly, a configuration may also be adopted in which the storage unit 21 of the relay apparatus 2 stores configuration information of all of the general-purpose ECUs 3, and each of the general-purpose ECUs 3 obtains the configuration information of all of the general-purpose ECUs 3 by communicating with the relay apparatus 2.

The ECU 3b on standby specifies the ECU 3a in operation that is executing the same type of program as the obtained update program, and transmits the signal for changing the state to the standby state, to the ECU 3a in operation, but there is no limitation thereto. A configuration may also be adopted in which the relay apparatus 2 specifies the ECU 3a in operation that is executing the same type of program as the obtained update program, and transmits the signal for changing the state to the standby state to the ECU 3a in operation.

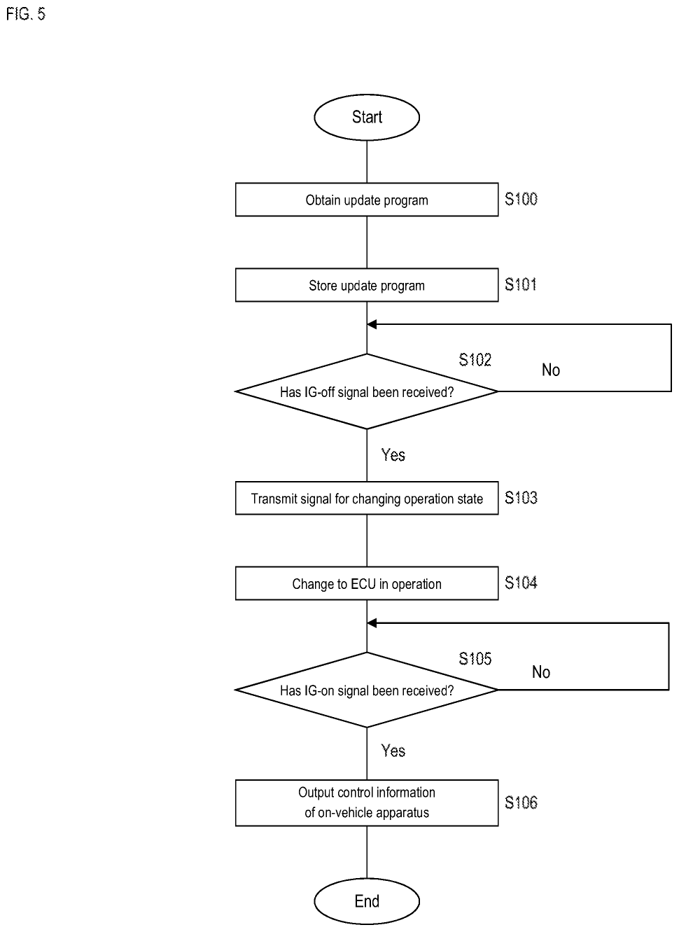

FIG. 5 is a flowchart illustrating processing of the control unit of a general-purpose ECU 3 (an ECU 3b on standby). The control unit 30 of the general-purpose ECU 3 that is the ECU 3b on standby (the control unit 30 of the ECU 3b on standby) waits for an update program relayed by the relay apparatus 2 while the vehicle C is in a running state (the IG switch 8 is on), and performs the following processing.

The control unit 30 of the ECU 3b on standby obtains an update program (step S100). If an old program is stored in the storage unit 31 of the ECU 3b on standby, the control unit 30 may delete the old program as preparation processing for obtaining the program. As a result of deleting the old program, it is possible to keep the storage region of the storage unit 31 of the ECU 3b on standby from becoming tight. The control unit 30 of the ECU 3b on standby stores the update program (step S101). The control unit 30 stores the obtained update program in the storage unit 31 of the ECU 3b on standby.

The control unit 30 of the ECU 3b on standby determines whether or not an IG off signal has been received (step S102). The ECU 3b on standby determines whether or not an IG off signal has been received based on the information regarding turning off of the IG switch 8 transmitted from the relay apparatus 2 (IG off signal), for example.

If an IG off signal has not been received (step S102: NO), the control unit 30 of the ECU 3b on standby performs loop processing to execute the processing in step S102 again.

If an IG off signal has been received (step S102: YES), the control unit 30 of the ECU 3b on standby transmits a signal for changing the operation state (step S103). The control unit 30 transmits the signal for changing the operation state (signal for changing the ECU 3a in operation to the ECU 3b on standby), to the ECU 3a in operation that is executing the same type of program as the obtained update program, in other words, a previous-version program of the update program. The ECU 3a in operation that has received the signal stores, in the storage unit 31 thereof, information regarding the signal, so as to change to an ECU 3b on standby. Alternatively, the ECU 3a in operation that has received the signal may change the operation state thereof from “in operation” to “on standby” in update information stored in the storage unit 31 thereof.

The control unit 30 of the ECU 3b on standby changes the ECU 3b on standby to an ECU 3a in operation (step S104). The control unit 30 of the ECU 3b on standby changes to an ECU 3a in operation by changing the operation state thereof from “on standby” to “in operation” in update information stored in the storage unit 31 thereof.

As a result of the IG switch 8 of the vehicle C being turned off and then turned on, the on-vehicle apparatus 7 corresponding to update program and the dedicated ECU 6 directly connected to the on-vehicle apparatus 7 is stopped and then started. As a result of changing the ECU 3b on standby that has received the update program to an ECU 3a in operation while the on-vehicle apparatus 7 corresponding to the update program is stopped, it is possible to prevent the on-vehicle apparatus 7 from being stopped in order only to apply the update program, and shorten the period during which the general-purpose ECUs 3 cannot control the on-vehicle apparatus 7.

The general-purpose ECU 3 that was the ECU 3a in operation before the on-vehicle apparatus 7 was stopped changes to an ECU 3b on standby while the on-vehicle apparatus 7 is stopped. The storage unit 31 of the general-purpose ECU 3 that has changed to an ECU 3b on standby stores an old program (a previous-version program of the update program), but the ECU 3b on standby is performing standby processing without executing the old program, and thus it is possible to prevent control of the on-vehicle apparatus 7 from being affected. Accordingly, the ECU 3b on standby has virtually stopped outputting information (signal) for controlling the on-vehicle apparatus 7.

When changing to an ECU 3a in operation, the control unit 30 corrects information regarding the operation state of the ECU, in configuration information stored in the storage unit 31 of the ECU. The correction content of the information regarding the operation state is to change the operation state of the ECU from “on standby” to “in operation”, and to change the operation state of the ECU 3a in operation that has transmitted the signal in the processing in step S103, from “in operation” to “on standby”. Furthermore, the correction content of the configuration information also includes changing the software unit number, version, and function group of the ECU changing to an ECU 3a in operation, to the software unit number, version, and function group of the obtained update program.

The control unit 30 transmits the corrected configuration information to the other general-purpose ECUs 3 and the relay apparatus 2. Each of the other general-purpose ECUs 3 that has received the configuration information replaces the configuration information stored therein with the received configuration information, and thereby the configuration information that includes the operation states (in operation or on standby) of the general-purpose ECUs 3 at the present point in time and the like can be shared.

The control unit 30 of the general-purpose ECU 3 that has changed to the ECU 3a in operation (the control unit 30 of the ECU 3a in operation) determines whether or not an IG-on signal has been received (step S105). The control unit 30 of the general-purpose ECU 3 that has changed to the ECU 3a in operation determines whether or not an IG off signal has been received, based on information regarding the on-state of the IG switch 8 (IG-on signal) transmitted from the relay apparatus 2, for example.

If an IG-on signal has not been received (step S105: NO), the control unit 30 of the general-purpose ECU 3 that has changed to the ECU 3a in operation performs loop processing in order to execute the processing in step S105 again.

If an IG-on signal has been received (step S105: YES), the control unit 30 of the general-purpose ECU 3 that has changed to the ECU 3a in operation outputs control information of the on-vehicle apparatus 7 (step S106). The control unit 30 executes the obtained update program, and thereby generates information for controlling the on-vehicle apparatus 7 corresponding to the update program, and transmits (outputs) the information to the dedicated ECU 6 directly connected to the on-vehicle apparatus 7.

As described above, a previous-version program (old program) corresponding to the update program is stored in the storage unit 31 of the general-purpose ECU 3 that has received the signal for changing the operation state, and has changed to the ECU 3b on standby. The general-purpose ECU 3 that has changed to the ECU 3b on standby performs standby processing for waiting for the next update program that is transmitted from the relay apparatus 2 without executing the old program. When the next update program is transmitted from the relay apparatus 2, the general-purpose ECU 3 that has changed to the ECU 3b on standby executes the processing in step S100 onward.

Every time an update program is transmitted from the relay apparatus 2, in other words every time update processing of a program (reprograming processing) is executed, the ECU 3b on standby obtains the update program and changes to an ECU 3a in operation, and thereby executes the update program. The ECU 3a in operation that was executing a previous-version program (old program) corresponding to the update program changes to an ECU 3b on standby. In this manner, every time update processing of a program is performed using an update program, the state of the ECU 3b on standby changes. The ECU 3b on standby does not generate or output information for controlling the on-vehicle apparatus 7, and thus can obtain the update program even when the on-vehicle apparatus 7 is in operation. Furthermore, a change from the ECU 3b on standby to the ECU 3a in operation is made in a very short period, for example, while the IG switch 8 is off, and thus it is possible to shorten a time during which the on-vehicle apparatus 7 cannot be controlled using the ECU 3a in operation. In addition, the ECU 3b on standby holds a previous-version program of the update program (old program), and thus, when a problem occurs in the update program, the ECU 3b on standby can perform rollback processing using the old program.

### Second Embodiment

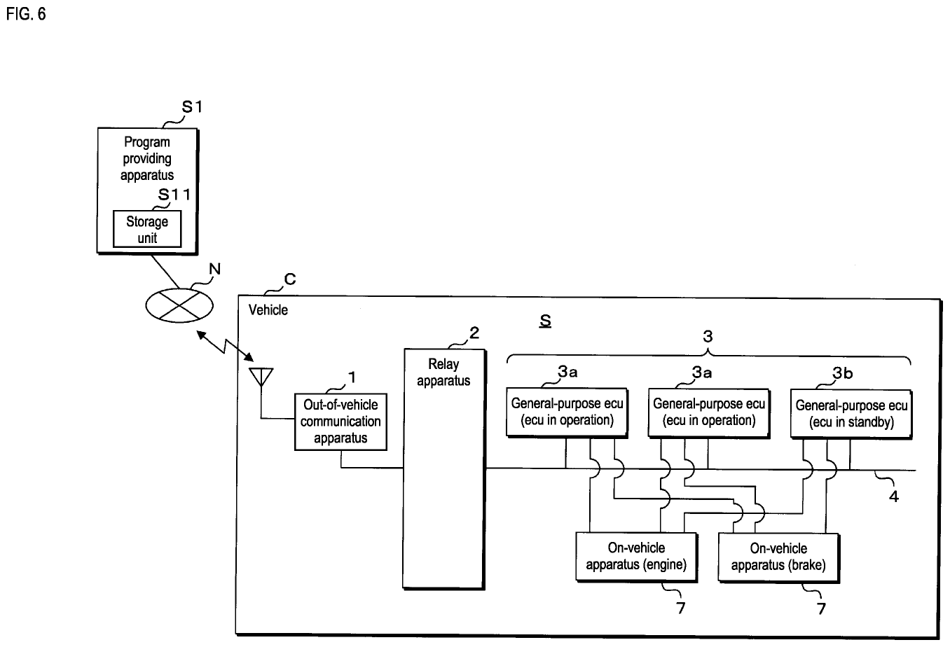

FIG. 6 is a schematic diagram illustrating the configuration of a program update system S according to a second embodiment (which does not include dedicated ECUs 6). The program update system S according to the second embodiment is different from the first embodiment in that the general-purpose ECUs 3 and the on-vehicle apparatuses 7 are connected for all of the combinations of the general-purpose ECUs 3 and the on-vehicle apparatuses 7.

The general-purpose ECUs 3 includes an ECU 3a in operation and an ECU 3b on standby similar to the first embodiment. All of the general-purpose ECUs 3 are communicably connected to all of the on-vehicle apparatus 7 that are to be controlled, for example, by wire harnesses such as serial cables. Each of the general-purpose ECUs 3 includes a relay apparatus 2 or an input/output I/F (not illustrated) that is similar to that of a dedicated ECU 6 according to the first embodiment, and the wire harness is connected to the input/output I/F.

FIG. 6 shows three general-purpose ECUs 3 and two on-vehicle apparatuses 7, as an example. The general-purpose ECUs 3 are connected to the two on-vehicle apparatuses 7 using two wire harnesses. Specifically, the general-purpose ECUs 3 and on-vehicle apparatuses 7 are connected using wire harnesses so as to cover all of the combinations of the general-purpose ECUs 3 and the on-vehicle apparatuses 7.

A general-purpose ECU 3 whose operation state is “in operation”, in other words, an ECU 3a in operation executes a program stored in the storage unit 31, generates information for controlling the on-vehicle apparatus 7 corresponding to the program, and outputs the generated information to the on-vehicle apparatus 7 via the input/output I/F.

It is possible to make the dedicated ECUs 6 unnecessary as a result of connecting the general-purpose ECUs 3 and the on-vehicle apparatuses 7, for all of the combinations of the general-purpose ECUs 3 and the on-vehicle apparatus 7.

The embodiments disclosed herein are to be considered as illustrative and non-limiting in all aspects. The scope of the present disclosure is indicated not by the above-stated meanings but by the claims, and all changes that come within the meaning and range of equivalency of the claims are intended to be embraced therein.

1. A program update system that performs processing for updating a program of on-vehicle ECUs mounted in a vehicle, the system comprising:
a plurality of general-purpose ECUs that are included among the on-vehicle ECUs, are each capable of executing a plurality of types of programs, and exhibit different functions in accordance with the type of program that is executed,
wherein the general-purpose ECUs include an ECU in operation that is in a state of outputting information for controlling an on-vehicle apparatus mounted in the vehicle and an ECU on standby that is in a state of not outputting information for controlling the on-vehicle apparatus,
when updating a program of the general-purpose ECUs,
the ECU on standby obtains an update program transmitted from an external server that is outside of the vehicle, stores the update program in a storage unit thereof, and changes to an ECU in operation that outputs information for controlling the on-vehicle apparatus, and
the ECU in operation that is executing a previous-version program corresponding to the update program stops outputting information for controlling the on-vehicle apparatus, and changes to an ECU on standby,
the plurality of general-purpose ECUs share information regarding an operation state indicating whether each of the general-purpose ECUs is in operation or on standby, and
the ECU on standby
specifies the ECU in operation that is executing the previous-version program corresponding to the update program, based on the shared information, and
transmits a signal for changing to a standby state, to the specified ECU in operation.

2. The program update system according to claim 1, wherein, when updating a program of the general-purpose ECUs, after an on-vehicle apparatus corresponding to the update program stops,
the ECU on standby changes to an ECU in operation that outputs information for controlling the on-vehicle apparatus, and
the ECU in operation that is executing the previous-version program corresponding to the update program stops outputting information for controlling the on-vehicle apparatus, and changes to an ECU on standby.

3. The program update system according to claim 1, wherein the ECU on standby has a program stored in the storage unit, the program having been executed when the ECU on standby was the ECU in operation, and, when obtaining the update program transmitted from the external server, the ECU on standby deletes the program that was executed when the ECU on standby was the ECU in operation.

4. The program update system according to claim 1, wherein the on-vehicle ECUs include the general-purpose ECU and a dedicated ECU directly connected the on-vehicle apparatus,
the general-purpose ECU is not directly connected to the on-vehicle apparatus, generates information for controlling the on-vehicle apparatus, and transmits the information to the dedicated ECU, and
the dedicated ECU receives the information transmitted by the general-purpose ECU, and controls the on-vehicle apparatus directly connected thereto based on the information.

5. The program update system according to claim 4, wherein the general-purpose ECU and the dedicated ECU are connected via a relay apparatus that integrates a plurality of communication systems, and
a communication system to which the general-purpose ECU is connected and a communication system to which the dedicated ECU is connected are different.

6. An update processing program that causes a computer to execute processing for:
changing a plurality of general-purpose ECUs, which are included among on-vehicle ECUs mounted in a vehicle, are each capable of executing a plurality of types of programs, and exhibit different functions in accordance with the type of program that is executed, to an ECU in operation that is in a state of outputting information for controlling an on-vehicle apparatus mounted in the vehicle or an ECU on standby that is in a state of not outputting information for controlling the on-vehicle apparatus,
when updating a program of the general-purpose ECUs,
causing the ECU on standby to obtain an update program transmitted from an external server that is outside the vehicle, and store the update program in a storage unit thereof, and changing the ECU on standby to an ECU in operation that outputs information for controlling the on-vehicle apparatus, and
causing the ECU in operation that is executing a previous-version program corresponding to the update program to stop outputting information for controlling the on-vehicle apparatus, and changing the ECU in operation to an ECU on standby,
causing the plurality of general-purpose ECUs to share information regarding an operation state indicating whether each of the general-purpose ECUs is in operation or on standby, and
causing the ECU on standby to:
specify the ECU in operation that is executing the previous-version program corresponding to the update program, based on the shared information, and
transmit a signal for changing to a standby state, to the specified ECU in operation.

7. The update processing program according to claim 6, further causing the computer to execute processing for causing the general-purpose ECU to generate information for controlling the on-vehicle apparatus, and to transmit the generated information to a dedicated ECU that is included among the on-vehicle ECUs and is directly connected to the on-vehicle apparatus.

8. The update processing program according to claim 7,
wherein the general-purpose ECU and the dedicated ECU are connected via a relay apparatus that integrates a plurality of communication systems, and
a communication system to which the general-purpose ECU is connected and a communication system to which the dedicated ECU is connected are different.

9. The program update system according to claim 2, wherein the ECU on standby has a program stored in the storage unit, the program having been executed when the ECU on standby was the ECU in operation, and, when obtaining the update program transmitted from the external server, the ECU on standby deletes the program that was executed when the ECU on standby was the ECU in operation.

10. The program update system according to claim 2, wherein the on-vehicle ECUs include the general-purpose ECU and a dedicated ECU directly connected the on-vehicle apparatus,
the general-purpose ECU is not directly connected to the on-vehicle apparatus, generates information for controlling the on-vehicle apparatus, and transmits the information to the dedicated ECU, and
the dedicated ECU receives the information transmitted by the general-purpose ECU, and controls the on-vehicle apparatus directly connected thereto based on the information.

11. The program update system according to claim 3, wherein the on-vehicle ECUs include the general-purpose ECU and a dedicated ECU directly connected the on-vehicle apparatus,
the general-purpose ECU is not directly connected to the on-vehicle apparatus, generates information for controlling the on-vehicle apparatus, and transmits the information to the dedicated ECU, and
the dedicated ECU receives the information transmitted by the general-purpose ECU, and controls the on-vehicle apparatus directly connected thereto based on the information.
